(19) United States
(12) Patent Application Publication
(10) Pub. No.: US 2009/0226876 A1
(43) Pub. Date: Sep. 10, 2009

(54) Compositions And Methods For Cardiovascular Surgery

(75) Inventors: Hemant Thatte, Medfield, MA (US); Shukri Khuri, Westwood, MA (US)

Correspondence Address: Peter G. Carroll;MEDLEN & CARROLL., LLP, Suite 350, 101 Howard Street, San Francisco, CA, 94105, US

(73) Assignees: THE UNITED STATES GOVERMENT as represented by the DEPARTMENT OF VETERAN'S AFFAIRS; PRESIDENT AND FELLOWS OF HARVARD COLLEGE

(21) Appl. No.: 12/274,053

(22) Filed: Nov. 19, 2008

Related U.S. Application Data
(60) Provisional application No. 61/003,853, filed on Nov. 19, 2007.

(51) Int. Cl. A01N 1/02

(52) U.S. Cl. 435/1.1

(57) ABSTRACT

The present invention relates to tissue preservation for autologous and heterologous transplantation. In particular the present invention provides compositions and methods for the long-term storage of surgical conduits ex vivo for subsequent use in coronary artery bypass grafting.

The present invention was made with government support. As such the government has certain rights in the invention.

### FIELD OF THE INVENTION

The present invention relates to tissue preservation for autologous and heterologous transplantation. In particular the present invention provides compositions and methods for the long-term storage of surgical conduits ex vivo for subsequent use in coronary artery bypass grafting.

### BACKGROUND OF THE INVENTION

The saphenous veins, and radial and internal thoracic arteries remain the bypass conduits of choice for coronary revascularization. A sharp increase in the median age of patients presenting with advanced atherosclerosis and an increase in the number of patients requiring multiple operations for coronary revascularization have resulted in a critical need for bypass conduits. Increased demand has resulted in the use of cryopreserved veins. However, anecdotal and clinical evidence paints a bleak picture of their patency rates when used for revascularization.

Tissue and organ preservation solutions have been designed to lengthen the time that a tissue or organ may remain viable extra-corporeally, and to maximize the performance of the tissue or organ following implantation. Examples of these solutions include: 1) the Stanford University solution (Swanson et al., J Heart Transplantation, 7:456-467, 1988); 2) the modified Collins solution (Swanson et al., supra, 1988; and Maurer et al., Transplantation Proceedings, 22:548-550, 1990); and 3) the University of Wisconsin solution (Belzer et al., U.S. Pat. No. 4,798,824). Of these, the University of Wisconsin (UW) solution is currently regarded as the industry standard, even though preservation period afforded by this solution is less than desirable. More recently, additional aqueous solutions have been developed for tissue and organ preservation (Stem et al., U.S. Pat. No. 5,552,267), although the complexity of these solutions has limited their utility.

The method of tissue and organ preservation, as well as the composition of the aqueous solutions employed, affects the success of the preservation endeavors. Several methods of cardiac preservation employing the above-referenced aqueous solutions have been described including: 1) warm arrest/cold ischemia; 2) cold arrest/macroperfusion; 3) cold arrest/microperfusion; and 4) cold arrest/cold ischemia. The first method involves arresting the heart with a warm cardioplegic solution prior to exsanguination and cold preservation. The warm arrest/cold ischemia method however, is not optimal due to the rapid depletion of myocardial energy stores during the warm period. The second method involves arresting the heart with a cold cardioplegic solution and continuous perfusion of the heart during the storage period. Although the cold arrest/macroperfusion method is better, continuous perfusion generates oxygen free radicals that can compromise post-transplant tissue or organ viability. Likewise, the third method of trickle perfusion involving arresting the heart with a cold cardioplegic solution also results in the generation of undesirable oxygen free radicals. The fourth method of preservation involves a cold cardioplegic arrest followed by a period of cold immersion of the heart. The fourth method is currently regarded as the industry standard in that it reliably preserves hearts for periods of four to six hours.

The paucity of surgical conduits useful for revascularization is indicative of a need in the art for improved compositions and methods for the long-term storage of saphenous veins and thoracic arteries ex vivo. Thus development of physiological solutions for protecting harvested bypass conduits and other organs during prolonged storage periods is desirable.

### SUMMARY OF THE INVENTION

The present invention relates to tissue preservation for autologous and heterologous transplantation. In particular the present invention provides compositions and methods for the long-term storage of surgical conduits for coronary artery bypass grafting.

The present invention provides compositions comprising a physiological salt solution, lacidipine, L-taurine and L-carnosine. In some preferred embodiments the composition further comprise an energy source, a reducing agent, an antioxidant, an ammonia detoxicant, and an anti-coagulant. In some particularly preferred embodiments, the energy source is D-glucose, the reducing agent is reduced glutathione, the antioxidant is ascorbic acid, the ammonia detoxicant is L-arginine, and the anti-coagulant is heparin.

In some preferred embodiments, the present invention provides compositions comprising a physiological salt solution, D-glucose, reduced glutathione, ascorbic acid, L-arginine, heparin, lacidipine, L-taurine, and L-carnosine. In some preferred embodiments, the physiological salt solution is Hanks' buffered salt solution (HBSS). In some embodiments, the composition further comprises an antibiotic. In some embodiments, the antibiotic is selected from the group consisting of an aminoglycoside, an amphenicol, an ansamycin, a beta-lactam, a lincosamide, a macrolide, a polypeptide and a tetracycline. In some embodiments, the tetracycline antibiotic is selected from the group consisting of chlortetracycline, clomocycline, demeclocycline, doxycycline, guamecycline, lymecycline, meclocycline, methacycline, minocycline, oxytetracycline, penimepicycline, pipacycline, rolitetracycline, sancycline, and tetracycline. In some preferred embodiments, the composition has a pH above 6.8 and below 8.0, more preferably a pH in the range of 7.2 to 7.6, and most preferably a pH of about 7.4.

In addition, the present invention provides methods comprising: providing a physiological salt solution comprising lacidipine, L-taurine, and L-carnosine; and storing an isolated blood vessel in the physiological salt solution under cold sterile conditions for an extended period of time to provide a stored blood vessel. In some embodiments, the physiological salt solution further comprises an energy source, a reducing agent, an antioxidant, an ammonia detoxicant, and an anti-coagulant. In some preferred embodiments, the energy source is D-glucose, the reducing agent is reduced glutathione, the antioxidant is ascorbic acid, the ammonia detoxicant is L-arginine, and the anti-coagulant is heparin. In some preferred embodiments, the isolated blood vessel is selected from the group consisting of a saphenous vein, a radial thoracic artery and an internal thoracic artery. In some particularly preferred embodiments the cold conditions comprise refrigeration (e.g., storage at a temperature of less than 10° C., preferably about 4° C.). In some preferred embodiments, the cold conditions do not involve cryopreservation (e.g., storage at a temperature of greater than 0° C.). In some embodiments, the extended period of time is from two days to two years, preferably from one week to one year, and more preferably several months (e.g., one, two, three, four, five, six, seven, eight, nine, ten, or eleven months). In preferred embodiments, integrity of an endothelial layer of the stored blood vessel remains largely intact. In some embodiments, the endothelial layer comprises less than 50% apoptotic cells (e.g., less than 40%, 30%, 25%, 20%, 15% or 10% apoptotic cells). In some embodiments, the endothelial layer comprises greater than 50% viable cells (e.g., greater than 50%, 60%, 70%, 75%, 80%, 85% or 90% viable cells). In some preferred embodiments, endothelial nitric oxide synthase (eNOS) expression by the stored blood vessel is detectable (e.g., comparable to levels expressed by freshly harvested blood vessels). In some preferred embodiments, von Willebrand factor (vWF) expression by the stored blood vessel is detectable (e.g., comparable to levels expressed by freshly harvested blood vessels).

Moreover, the present invention provides kits for storing an isolated blood vessel in a viable state for an extended period of time, comprising: a physiological salt solution or a concentrate thereof, in a sterile container, wherein said physiological salt solution comprises lacidipine, L-taurine, and L-carnosine; and instructions for storing an isolated blood vessel in a viable state for an extended period of time in the sterile container, wherein the extended period of time comprises several months. In some embodiments, the composition further comprises an energy source, a reducing agent, an antioxidant, an ammonia detoxicant, and an anti-coagulant. In some preferred embodiments, the energy source is D-glucose, the reducing agent is reduced glutathione, the antioxidant is ascorbic acid, the ammonia detoxicant is L-arginine, and the anti-coagulant is heparin.

The present invention also provides compositions comprising a physiological salt solution, D-glucose, reduced glutathione, ascorbic acid, L-arginine, lacidipine and L-taurine, wherein the physiological salt solution comprises potassium chloride. In some preferred embodiments, the physiological salt solution is Hanks' buffered salt solution (HBSS). In some particularly preferred embodiments, the potassium chloride is present in a concentration of less than 40 mM (e.g., preferably 10-30 mM). In other particularly preferred embodiments, the potassium chloride is present in a concentration of greater than 30 mM (e.g., preferably 40-90 mM). In some embodiments, the composition further comprises an anti-coagulant, which in preferred embodiments is heparin. In some preferred embodiments, the composition further comprises an antibiotic. In some embodiments, the antibiotic is selected from the group consisting of an aminoglycoside, an amphenicol, an ansamycin, a beta-lactam, a lincosamide, a macrolide, a polypeptide and a tetracycline. In some preferred embodiments, the antibiotic is a tetracycline antibiotic (e.g., present in a concentration of 0.1 to 100 μM). In some preferred embodiments, the tetracycline antibiotic is selected from the group consisting of chlortetracycline, clomocycline, demeclocycline, doxycycline, guamecycline, lymecycline, meclocycline, methacycline, minocycline, oxytetracycline, penimepicycline, pipacycline, rolitetracycline, sancycline, and tetracycline. In some preferred embodiments, the composition further comprises an osmotic diuretic. In some embodiments, the osmotic diuretic is selected from the group consisting of glycerin, isosorbide, mannitol and urea. In some preferred embodiments, the osmotic diuretic is mannitol (e.g., present in a concentration of 300-350 mOsm/liter). In some preferred embodiments, the composition further comprises a cannabinoid receptor agonist (e.g., present in a concentration of 1 nM to 1 mM. In some embodiments, the cannabinoid receptor agonist comprises one or both of arachidonyl ethanolamide (anandamide) or 2-arachidonylglycerol (2AG). In some embodiments, the composition has a pH above 5.0 and below 8.0, preferably in the range of 5.5 to 7.5, and more preferably about 7.4.

In addition the present invention provides methods comprising: providing a physiological salt solution comprising D-glucose, reduced glutathione, ascorbic acid, L-arginine, lacidipine and L-taurine, wherein the physiological salt solution comprises potassium chloride; and storing cardiac myocytes in the physiological salt solution under sterile conditions to provide stored cardiac myocytes. In some embodiments, the cardiac myocytes comprise atrial tissue. In some embodiments, the storing is done for a time period of 30 min to 3 hours. In some preferred embodiments, the stored cardiac myocytes comprises less than 50% apoptotic cells (e.g., less than 40%, 30%, 25%, 20%, 15% or 10% apoptotic cells). In some preferred embodiments, the stored cardiac myocytes comprise greater than 50% viable cells (e.g., greater than 50%, 60%, 70%, 75%, 80%, 85% or 90% viable cells). In some embodiments, the stored cardiac myocytes express little to no apoptotic markers (e.g., APAF-1, cytochrome C, and caspase 3), which in preferred embodiments is comparable to levels expressed by cardiac myocytes before storage or to levels expressed by freshly harvested atrial tissue). In some preferred embodiments, the physiological salt solution further comprises an osmotic diuretic. In some embodiments, the osmotic diuretic is selected from the group consisting of glycerin, isosorbide, mannitol and urea. In some preferred embodiments, the osmotic diuretic is mannitol (e.g., present at a concentration of 300-350 mOsm/liter). In some embodiments, the physiological salt solution further comprises a cannabinoid receptor agonist (e.g., present in a concentration of 1 nM to 1 mM). In some preferred embodiments, the cannabinoid receptor agonist comprises one or both of arachidonyl ethanolamide (anandamide) or 2-arachidonylglycerol (2AG).

Moreover the present invention provides kits for storing cardiac myocytes in a viable state, comprising: a physiological salt solution or a concentrate thereof in a sterile container, wherein the physiological salt solution comprises D-glucose, reduced glutathione, ascorbic acid, L-arginine, lacidipine L-taurine, and potassium chloride; and instructions for storing cardiac myocytes in a viable state for a period of time in the sterile container, wherein the period of time comprises greater than 30 minutes (e.g., 30 min to 3 hours). In some embodiments, the physiological salt solution further comprises an osmotic diuretic. In some embodiments, the osmotic diuretic is selected from the group consisting of glycerin, isosorbide, mannitol and urea. In some preferred embodiments, the osmotic diuretic is mannitol (e.g., present in a concentration of 300-350 mOsm/liter). In some embodiments, the physiological salt solution further comprises a cannabinoid receptor agonist (e.g., present in a concentration of 1 nM to 1 mM). In some preferred embodiments, the cannabinoid receptor agonist comprises one or both of arachidonyl ethanolamide (anandamide) or 2-arachidonylglycerol (2AG).

### BRIEF DESCRIPTION OF THE DRAWINGS

FIG. 1 depicts a human saphenous vein that had been stored ex vivo for an extended period of time. Panels A and B depict a vein stored in GALA for over nine months at 4° C. and as recently retrieved from long term storage, respectively. Panel C illustrates the suturing of the proximal end of a stored vein. Panel D illustrates the stored vein's structural integrity as demonstrated by the suture remaining in place even after prolonged forceful tugging.

FIG. 2 provides images obtained using multiphoton microscopy of a human saphenous vein that had been stored ex vivo for an extended period of time (submersed in GALA for over nine months at 4° C.). Before imaging, the saphenous vein was labeled with calcein-AM and an ethidium homodimer to assess cell viability. Panels A and B provide brightfield and fluorescence images, respectively. Light areas correspond to viable endothelial cells.

FIG. 3 provides images of stored vein sections stained with HE by the Pathology Laboratory, VA Medical Center, Roxbury, Mass. As shown in panels A and B, the structure of the veins was maintained by storage of submersed in GALA for over nine months at 4° C.

FIG. 4 provides an immunoblot comparison of freshly harvested veins and stored veins. Panels A and B illustrate that fresh and stored veins express comparable amounts of eNOS and vWF, respectively.

### DEFINITIONS

To facilitate an understanding of the present invention, a number of terms and phrases are defined below:

The terms “cardiopulmonary bypass” and “CPB” refer to techniques that temporarily take over the function of the heart and lungs as, for example, in open-heart surgery. Blood returning to the heart is diverted through a heart-lung machine (a pump-oxygenator) before returning it to the arterial circulation. The machine does the work both of the heart (pump blood) and the lungs (supply oxygen to red blood cells). Surgeries that utilize cardiopulmonary bypass include coronary artery bypass surgery, repair and/or replacement of cardiac valves (e.g., aortic, mitral, tricuspid, pulmonic), repair and/or replacement of large septal defects (e.g., atrial, ventricular atrioventricular), repair and/or palliation of congenital heart defects (e.g., Tetralogy of Fallot, transposition of the great vessels), transplantation (e.g., heart, lung, heart-lung), repair of some large aneurysms (e.g., aortic, cerebral), pulmonary thromboendarterectomy and pulmonary thrombectomy.

As used herein, the terms “coronary artery bypass grafting” and CABG” refer to a form of bypass surgery used to create new routes around narrowed and blocked coronary arteries, permitting increased blood flow to deliver oxygen and nutrients to the heart muscle. The bypass graft for a CABG can be a vein from the leg (e.g., saphenous vein) or an inner chest-wall artery.

The term “cardioplegia” as used herein refers to the paralysis of the heart, such as in electively in stopping the heart during cardiac surgery. Cardioplegia may be brought about using chemicals, cold or electrical stimulation.

### GENERAL DESCRIPTION OF THE INVENTION

During heart bypass surgery, veins and/or arteries are removed from the patient and stored outside of the body until they are placed on the heart. Once the vessels are grafted on the heart, 10-25% of them fail to transport blood within one year after the operation, thus requiring another surgery to correct the problem. In case of patients who do not have other vessels available to replace the damaged vessels, the surgeon is frequently compelled to use cryopreserved (frozen) blood vessels as replacements. However, cryopreserved vessels also tend to fail to transport blood and do so within as little as one month after the operation, creating a serious post surgery problem. Thus there is a need for alternatively preserved veins and/or arteries that remain viable despite long-term storage.

Surprisingly during development of the present invention, compositions and methods comprising supplemented GALA solutions were found to be suitable for preserving blood vessels in a viable state for an extended period of time (e.g., months to more than a year) in the absence of cryopreservation. The supplemented GALA solutions of the present invention contain nutrients that are crucial for adequate protection of blood vessel cells, which in turn dictates how long these grafts continue to transport blood. The supplemented GALA solutions also contain ingredients that enable the cells to resist the damaging effects of prolonged storage. Heart valves, and other tissues can also be successfully stored in this solution, thus reducing the need for porcine or chemically preserved heart valves for cardiac surgery. Similarly, the supplemented GALA solutions can also be used to store whole organs for several hours ex vivo, prior to implantation. This extended period of organ protection permits their procurement from farther distances than had heretofore been possible, thus increasing the availability of these much needed donor organs.

### DETAILED DESCRIPTION OF THE INVENTION

The present invention relates to tissue preservation for autologous and heterologous transplantation. In particular the present invention provides compositions and methods for the long-term storage of surgical conduits ex vivo for subsequent use in coronary artery bypass grafting.

### I. Original GALA Solutions

The intraoperative preservation of surgical conduits prior to performance of coronary artery bypass grafting (CABG) is an important factor in the protection of the endothelial cells. The relationship between endothelial cell preservation and long-term patency is well established. Endothelial cells are known play important roles in regulating vasomotor, platelet anticoagulant, procoagulant, and fibrinolytic functions. These activities of the endothelium allow for control of blood flow, as well as thrombosis (e.g., blood clotting) in the event of endothelial injury. A physiological salt solution containing D-glucose, reduced glutathione, ascorbic acid, and L-arginine (GALA) was previously shown to be suitable for preserving endothelial function for an increased length of time as compared to Hank's buffered salt solution (HBSS) and other storage solutions (See e.g., U.S. Pat. No. 6,569,615, U.S. Publication No. 2004/0102415, and U.S. Publication No. 2007/0110740, all herein incorporated by reference in their entirety). Saphenous veins of over 1600 patients (cardiac and peripheral vascular surgery) have been preserved in GALA at the VA Hospital in West Roxbury, Mass., over the last four years. Saphenous vein grafts stored in GALA for up to 24 hours have shown outstanding results in terms of their redo rates (e.g., decreased frequency of failed vessels).

In recent years the number of small-vessel bypass procedures has increased sharply due to increases in atherosclerosis, diabetes and other vessel diseases, as well as an increase in the number of patients requiring multiple operations for coronary revascularization. As such the need for reliable bypass conduits has become greater (Bilfinger et al., Ann Thorac Surg, 63:1063-1069, 1997; and Stevens et al., J Vasc Surg, 12:361-366, 1990). Though autologous vessel grafts are the conduits of choice, repeat procedures, surgical removal, phlebitis, previous stripping and inadequate caliber can preclude the successful use of autologous bypass conduits. Therefore, reliable alternatives are needed. Synthetic conduits of polytetrafluoroethylene and Dacron have yielded very poor patency rates. Similarly, allograft manipulations including glutaraldehyde treatment (Hasoon et al., J Vasc Surg, 4:243-250, 1986), lyophilization (Goldman et al., Cryobiology, 18:306-312, 1981; and Goldman et al., Transplant Proc, 11:1510-1511, 1979), and cryopreservation (Bilfinger et al., Ann Thorac Surg, 63:1063-1069, 1997; Bambang et al., J Thorac Cardiovasc Surg, 110:998-1004, 1995; and Gu et al., World J Gastroenterol, 10:555-559, 2004) have met with limited success with unacceptably low patency rates. Manipulation of blood vessels using these methods has resulted in extensive damage to the endothelium and/or smooth muscle cells resulting in poorly functioning vessels. Accordingly, the use of these vessels for revascularization leads to restenosis and conduit failure within as little as three weeks post-surgery due to the inability of the endothelium and smooth muscle cells to participate in anticoagulation, immunovascular and vasomotor functions (Bilfinger et al., Ann Thorac Surg, 63:1063-1069, 1997). Because of the lack of viable alternatives to stored autologous and allogeneic blood vessels it is imperative to utilize improved techniques for preserving functionally viable surgical conduits.

### II. Supplemented GALA Solutions

As described herein, the compositions and methods of the present invention involving the use of supplemented GALA solutions provide heretofore unavailable alternatives to cryopreserved vessels for surgical revascularization when freshly harvested veins are arteries cannot be obtained. In particular as described in the experimental examples below, surgical conduits can be stored in supplemented GALA solutions in a viable state for surprisingly long periods of time (e.g., days to months and possibly years) after harvest. Supplemented GALA solutions of the present invention comprise a physiological salt solution, an energy source, a reducing agent, an antioxidant, an ammonia detoxicant, and an anti-coagulant, further supplemented with one or more of lacidipine, taurine and L-carnosine, or related compounds.

The physiological salt solution of the present invention is an isotonic aqueous solution comprising one or more inorganic salts. In some preferred embodiments, the physiological salt solution is a buffered solution such as Hanks' balanced salt solution (HBSS) containing D-glucose as the energy source. Other buffered salt solutions for maintaining physiological pH and osmotic pressure include but are not limited to phosphate buffered saline (PBS), Dulbecco's PBS (D-PBS), Tris-buffered saline (TBS), Earle's balanced salt solution (EBSS), standard saline citrate (SSC) and HEPES-buffered saline (HBS).

TABLE 1
Hanks' Balanced Salt Solution (HBSS)*

| | 1X Liquid | 10X Liquid |
|---|---|---|
| components | (g/L) | (g/L) |
| CaCl₂ (anhydrous) | 0.14 | 1.40 |
| KCl | 0.40 | 4.00 |
| KH₂PO₄ | 0.06 | 0.60 |
| MgCl₂•6H₂O | 0.10 | 1.00 |
| MgSO₄•7H₂O | 0.10 | 1.00 |
| NaCl | 8.00 | 80.00 |
| NaHCO₃ | 0.35 | — |
| Na₃HPO₄ | 0.048 | — |
| Na₂HPO₄•7H₂O | — | 0.90 |
| D-glucose† | 1.00 | 10.00 |

*The pH is adjusted as necessary with 1N hydrochloric acid or 1 N sodium hydroxide to a final pH of 7.2 to 7.6, preferably 7.4.
†A suitable concentration range for D-glucose is 0.25-25.0 mM, preferably about 5.6-11.1 mM (1.0 to 2.0 g/L).

The reducing agent of the present invention is a compound that donates an electron in an oxidation-reduction reaction. In some preferred embodiments, the reducing agent is reduced glutathione, which acts as a sulfhydryl buffer, reducing disulfide bonds in proteins to cysteines. Other reducing agents include but are not limited to beta-mercaptoethanol (BME) and dithiothreitol (DTT).

The antioxidant of the present invention is a compound that inhibits the oxidation of another compound, by removing free radical intermediates, and by becoming oxidized (e.g., acting as a reducing agent). In some preferred embodiments, the antioxidant is ascorbic acid, (vitamin C). Other antioxidants include but are not limited to butylated hydroxyanisole (BHA), butylated hydroxytoluene (BHT), glutathione, alpha-tocopherol (vitamin E), beta-carotene (vitamin A), and alpha-lipoic acid.

The ammonia detoxicant of the present invention is a compound that neutralizes the metabolic waste product, ammonia. In some preferred embodiments, the ammonia detoxicant is the nitric oxide synthase substrate L-arginine (e.g., L-arginine HCl). Another ammonia detoxicant includes but is not limited to L-citrulline malate.

The anti-coagulant of the present invention is a compound that inhibits blood clotting. In some preferred embodiments, the anti-coagulant is a platelet-aggregation inhibitor such as heparin. Alternatively, the platelet-aggregation inhibitor is a compound selected from but not limited to antithrombin III, bemiparin, dalteparin, danaparoid, enoxaparin, nadroparin, parnaparin, reviparin, sulodexide, and tinzaparin. Other anti-coagulants include but are not limited to direct thrombin inhibitors such as hirudin. Alternatively, the direct thrombin inhibitor is a compound selected from but not limited to argatroban, bivalirudin, dabigatran, desirudin, lepirudin, melagatran, and zimelagatran.

In some preferred embodiments, the supplemented GALA solution comprises the calcium channel blocker, lacidipine (MOTENS). Alternatively, the calcium channel blocker is another dihydropyridine-type compound selected from but not limited to amlodipine (NORVASC), aranidipine, barnidipine, benidipine, cilnidipine, efonidipine, elgodipine, felodipine (PLENDIL), isradipine, lercanidipine (ZANIDIP), manidipine, nicardipine (CARDENE), nifedipine (PROCARDIA or ADALAT), nilvadipine, nimodipine (NIMOTOP), nisoldipine (SULAR), and nitrendipine (CARDIF or NITREPIN). Alternatively, the calcium channel blocker is an arylalkylamine-type compound selected from but not limited to bepridil, clentiazem, diltiazem (CARDIZEM), fendiline, gallopamil, mibrefradil, prenylamine, semotiadil, terodiline, and verapamil (CALAN or ISOPTIN). In still further embodiments, the calcium channel blocker is either a piperazine-type compound selected from but not limited to cinnarizine, dotarizine, flunarizine, lidoflazine, and lomerizine, or a compound selected from but not limited to bencyclane, etafenone, fantofarone, monatepil, and perhexyline.

In some preferred embodiments, the supplemented GALA solution comprises the sulfur containing amino acid, L-taurine. Alternatively or additionally the sulfur containing amino acid comprises methionine or cysteine.

In some preferred embodiments, the supplemented GALA solution comprises the imidazole-containing dipeptide, L-carnosine (β-alanyl-L-histidine). Alternatively or additionally the imidazole-containing compound comprises anserine or homocarnosine.

In additional preferred embodiments, the supplemented GALA solution comprises one or more essential amino acids selected from the group consisting of histidine, isoleucine, leucine, lysine, methionine, phenylalanine, threonine, tryptophan and valine.

In additional preferred embodiments, the supplemented GALA solution comprises one or more conditionally essential amino acids selected from the group consisting of arginine, cysteine, glycine and tyrosine.

In additional preferred embodiments, the supplemented GALA solution comprises one or more amino acid components of the urea cycle, selected from the group consisting of arginine, ornithine and citrulline.

In additional preferred embodiments, the supplemented GALA solution comprises one or more non-essential amino acids selected from the group consisting of alanine, asparagine, aspartic acid, glutamine, glutamic acid, ornithine, proline, serine, and taurine.

TABLE 2
GALA and Exemplary Supplements

| | 1X Liquid | 1X Liquid | | 1X Liquid |
|---|---|---|---|---|
| components | [range] mM | [preferred] mM | | [preferred] (g/L) |
| reduced | 0.02-2.0 mM | 1.0 | mM | 0.307 |
| glutathione | | | | |
| ascorbic acid | 0.01-1.0 mM | 0.5 | mM | 0.088 |
| L-arginine•HCl | 0.01-1.0 mM | 0.5 | mM | 0.106 |
| heparin | 1.0-100 U/mL | 50 | U/mL | — |
| lacidipine | 0.02-2.0 | 1.0 | mM | 0.456 |
| L-taurine | 0.20-20 | 10 | mM | 1.252 |
| L-carnosine | 0.20-20 | 10 | mM | 2.262 |

### EXPERIMENTAL

The following examples are provided in order to demonstrate and further illustrate certain preferred embodiments and aspects of the present invention and are not to be construed as limiting the scope thereof.

In the experimental disclosure which follows, the following abbreviations apply: N (normal); M (molar); mM (millimolar); μM (micromolar); mol (moles); mmol (millimoles); μmol (micromoles); nmol (nanomoles); pmol (picomoles); g (grams); mg (milligrams); μg (micrograms); ng (nanograms); l or L (liters); ml (milliliters); μl (microliters); cm (centimeters); mm (millimeters); μm (micrometers); nm (nanometers); ° C. (degrees Centigrade); HBSS (Hank's balanced salt solution); GALA (physiological salt solution comprising reduced Glutathione, Ascorbic acid, and L-Arginine); and SVG (saphenous vein graft).

### Example 1

### Supplemented GALA Solutions

Hank's balanced salt solution (HBSS) is a commercially available physiological salt solution (Gibco/BRL) containing D-glucose 1.0 g/L, calcium chloride (anhydrous) 0.14 g/l, potassium chloride 0.4 g/l, potassium phosphate 0.06 g/l, magnesium chloride 6H₂O 0.1 g/l, magnesium chloride 7H₂O 0.1 g/l, sodium chloride 8 g/l, sodium bicarbonate 0.35 g/l, and sodium phosphate 0.048 g/l. To prepare the solution referred to herein as GALA (Glutathione, Ascorbic acid, L-Arginine), HBSS was modified by the addition of reduced glutathione, ascorbic acid (vitamin C), L-arginine, and heparin to a final concentration of 1000 μM, 500 μM, 500 μM, and 50 Units/ml, respectively, and the pH was adjusted (e.g., to a slightly acid or neutral pH, typically about 7.4) using 10 M sodium hydroxide (as described in Thatte and Khuri, Ann Thorac Surg, 72:S2245-S2252, 2001; U.S. Pat. No. 6,569,615; U.S. Publication No. 2004/0102415; and U.S. Publication No. 2007/0110740, all herein incorporated by reference in their entirety). The GALA solution provides free radical scavengers, antioxidants, a nitric oxide substrate, a reducing agent, an energy source (glucose), an anti-coagulant, and physiological concentrations of electrolytes and buffers.

During development of the present invention, the GALA solution is further modified for long-term preservation of surgical conduits and other tissues. The supplemented GALA solutions further comprise one or more of lacidipine (1.0 pM to 1.0 mM), L-taurine (5.0 to 15 mM) and L-carnosine (1.0 to 10 mM). Lacidipine (CAS No. 103890-78-4) is a vasorelaxant calcium channel blocker that modulates nitric oxide and/or endothelin levels (Crespi, Curr Vasc Pharmacol, 3:195-205, 2005). L-taurine (CAS No. 107-35-7) is a sulfur-containing organic acid that acts as an antioxidant in addition to playing roles in osmoregulation and membrane stabilization (Milei et al., Am Heart J, 123:339-345, 1992; Ohno et al., Asian Cardiovasc Thorac Ann, 7:267-271, 1999; and Messina and Dawson, Adv Exp Med Biol, 483:355-367, 2000). Taurine also preserves aerobic metabolism and prevents lactic acidosis. Moreover, L-carnosine (CAS No. 305-84-0) also known as β-alanyl-L-histidine, is a dipeptide composed of the two amino acids β-alanine and L-histidine. Carnosine performs a remarkable variety of functions (Garibala and Sinclair, Age and Aging, 29:207-201, 2000), such as anti-oxidation, anti-glycation, pH buffering, and chelation of divalent metal cations (particularly copper, Cu²⁺).

### Example 2

### Long Term Preservation of Surgical Conduits

After approval from the Human Studies Subcommittee, discarded segments of saphenous vein grafts (SVG) used as bypass conduits were obtained from the operating room and transported to the laboratory for experimental work. Human saphenous veins were excised and obtained from male patients undergoing cardiac bypass surgery at the West Roxbury VA Medical Center, according to the protocol established by the scientific evaluation committee at the VA Medical Center. A 100 mm segment of 11.5 mm diameter was excised from the SVG or its branch in the operating room and immediately transferred to a sterile container containing a supplemented GALA solution and stored unopened at 4° C. for several months to more than one year. To study the protective effects of supplemented GALA during prolonged storage conditions, viability and functionality assays were completed using segments of saphenous vein stored in a supplemented GALA solution for nine months.

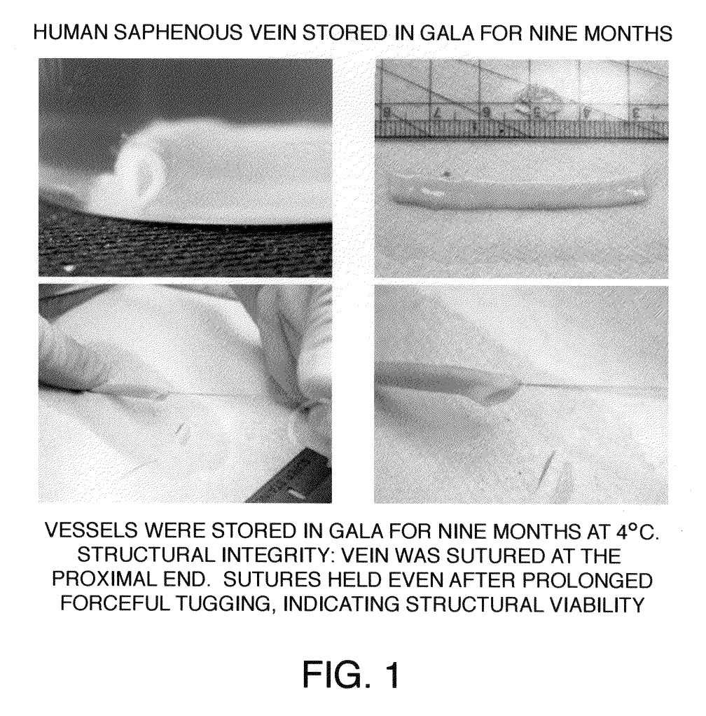

Structural integrity of the stored vessels was assessed. As shown in FIG. 1, the surface and lumen of the vessel appeared normal without any visible damage. Next a suture was threaded through the vessel orifice and tugged strongly to mimic anastomosis in the operating room. The suture held without rupturing or tearing of the vessel. This observation indicates that structural integrity of the vessel was maintained even after prolonged storage (e.g., several months) in the absence of cryopreservation.

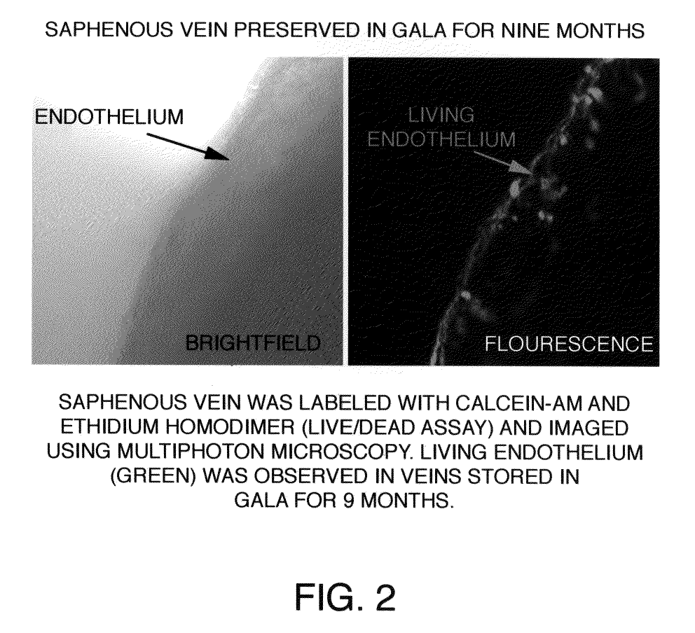

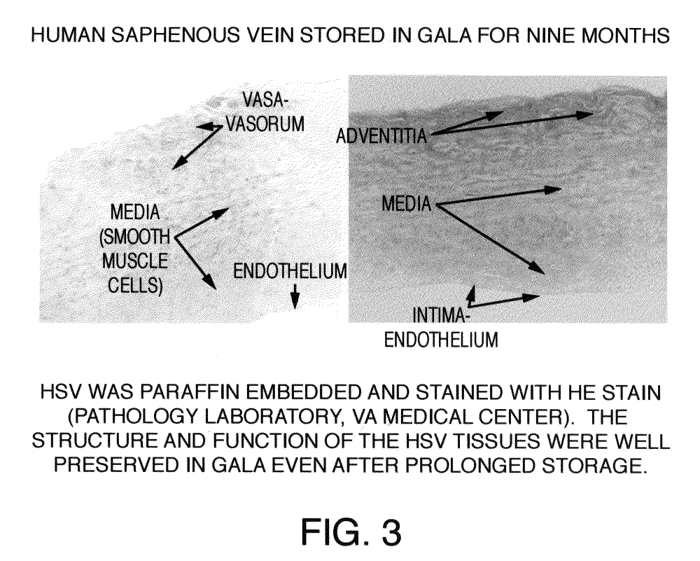

Cell viability was measured using calcein-dependent green fluorescence and cell death was measured using ethidium homodimer-mediated red fluorescence in a live-dead assay as previously described (Thatte et al., Ann Thorac Surg, 75:1145-1152, 2003; and Biswas et al., J Surg Res, 95:37-43, 2001, herein incorporated by reference in their entirety). Stored veins were incubated with a 15 μM solution of calcein/ethidium homodimer for 30 minutes at 21° C. for loading of the fluorophores. Imaging of vein segments was performed using the BioRad MRC 1024 ES multi-photon imaging system coupled with a mode-locked Spectra-Physics tunable MaiTai titanium/sapphire laser system tuned to 820 nm and a Zeiss Axiovert S100 inverted microscope equipped with a high-quality water immersion 40×/1.2 NA objective. The viability of the saphenous veins was examined under 40× and/or 80× (zoom) magnification. The lumen and endothelial cell layers were identified by XYZ scanning at depths ranging from 30-200 μm. Intact endothelial and smooth muscle layers were apparent in the transmitted light image provided in FIG. 2A. Corresponding green fluorescence indicative of a living, viable endothelium is shown in FIG. 2B. The absence of red fluorescence indicates that dead cells were not observable in the stored vessel segment. As shown in FIG. 3 histochemical microscopy with standard HE staining illustrated the structural integrity of the adventitia, smooth muscle and endothelial layers of the sectioned stored vessel. Thus the HE staining confirmed the multiphoton imaging findings.

Previous studies employing the live-dead assay revealed that storage conditions of the prior art including maintenance of saphenous veins at room temperature (e.g., 21° C.) in HLS, heparinized blood or RPMI/M199 were ineffective in maintaining viable vessels (e.g., 25% or fewer viable cells after a 60 to 90 minute storage period). In addition, although maintenance of saphenous veins in HBSS increased the length of time in which the vessels could be stored without significant cell death, these storage conditions were also limiting (e.g., 25% or fewer viable cells after four to five hours). In contrast, maintenance of saphenous veins in a GALA solution lacking lacidipine and taurine at 4° C. was effective in maintaining vessels with a largely intact endothelial cell layer for up to 24 hours (See, Table 1 of U.S. Pat. No. 6,569,615; U.S. Publication No. 2004/0102415; and U.S. Publication No. 2007/0110740). However, prior to development of the present invention, one skilled in the art would not have expected to be able to maintain harvested surgical conduits in a viable state for an extended period of time (e.g., days, weeks, or months) in any storage solution the absence of cryopreservation.

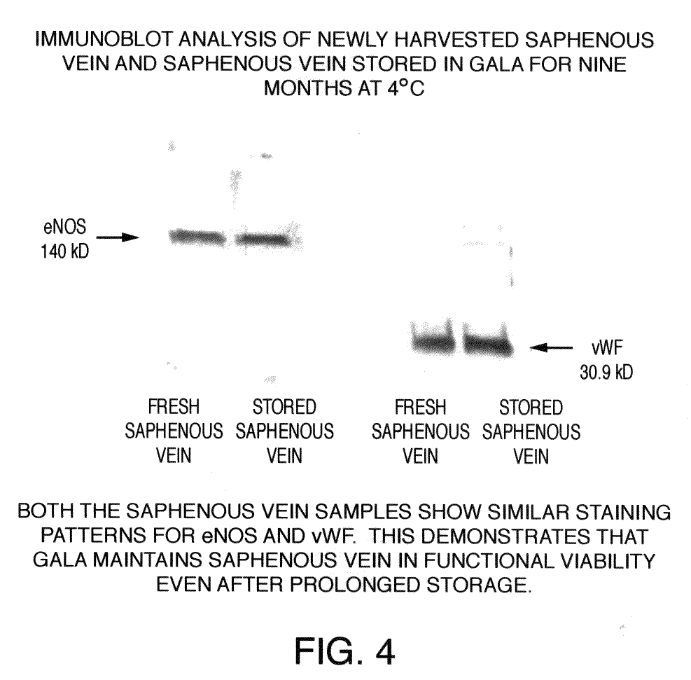

Functionality of the stored veins was assessed by SDS-PAGE and immunoblotting. Only living endothelial cells synthesize eNOS and secrete vWF. FIG. 4 depicts the presence of both eNOS and vWF in stored vessels at levels comparable to that observed in freshly harvested vessels, indicating that the surgical conduits were functional as well as viable even after long term storage in a supplemented GALA solution. These results clearly demonstrate that a supplemented GALA solution is suitable for protecting the vessel endothelium, as well as the smooth muscle layer during extended storage at 4° C. Thus long term protective effect of a supplemented GALA solution is clearly significant and surprising. Thus as described herein, storage conditions involving a supplemented GALA solution provide a feasible alternative to cryopreservation for the long-term preservation of harvested vessels. This is contemplated to increase the availability of viable human conduits for surgical revascularization.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention, which are obvious to those skilled in the relevant fields are intended to be within the scope of the following claims.

We claim:

1. A method comprising: storing an isolated blood vessel in a physiological salt solution comprising lacidipine, L-taurine, and L-carnosine, under cold sterile conditions for an extended period of time to provide a stored blood vessel.

2. The method of claim 1, wherein said physiological salt solution further comprises an energy source, a reducing agent, an antioxidant, an ammonia detoxicant, and an anti-coagulant.

3. The method of claim 2, wherein the energy source is D-glucose, the reducing agent is reduced glutathione, the antioxidant is ascorbic acid, the ammonia detoxicant is L-arginine, and the anti-coagulant is heparin.

4. The method of claim 1, wherein said isolated blood vessel is selected from the group consisting of a saphenous vein, a radial thoracic artery and an internal thoracic artery.

5. The method of claim 1, wherein said cold conditions comprise refrigeration.

6. The method of claim 1, wherein said cold conditions do not involve cryopreservation.

7. The method of claim 1, wherein said extended period of time is from one week to one year.

8. The method of claim 1, wherein said extended period of time is comprises several months.

9. The method of claim 1, wherein integrity of an endothelial layer of said stored blood vessel remains largely intact.

10. The method of claim 9, wherein said endothelial layer comprises less than 50% apoptotic cells.

11. The method of claim 9, wherein said endothelial layers comprises greater than 50% viable cells.

12. The method of claim 9, wherein endothelial nitric oxide synthase expression by said stored blood vessel is detectable.

13. The method of claim 9, wherein von Willebrand factor expression by said stored blood vessel is detectable.

14. A method comprising:
i) providing a physiological salt solution comprising D-glucose, reduced glutathione, ascorbic acid, L-arginine, lacidipine and L-taurine, wherein said physiological salt solution comprises potassium chloride; and
ii) storing cardiac myocytes in said physiological salt solution under sterile conditions to provide stored cardiac myocytes.

15. The method of claim 14, wherein said cardiac myocytes comprise atrial tissue.

16. The method of claim 14, wherein said storing is done for a time period of 30 min to 3 hours.

17. The method of claim 16, wherein said stored cardiac myocytes comprises less than 50% apoptotic cells.

18. The method of claim 16, wherein said stored cardiac myocytes comprise greater than 50% viable cells.

19. The method of claim 14, wherein said physiological salt solution further comprises an osmotic diuretic.

20. The method of claim 19, wherein said osmotic diuretic is mannitol.

21. The method of claim 14, wherein said physiological salt solution further comprises a cannabinoid receptor agonist.

22. The method of claim 21, wherein said cannabinoid receptor agonist comprises one or both of arachidonyl ethanolamide (anandamide) or 2-arachidonylglycerol (2AG).
